(19) United States
(12) Patent Application Publication
(10) Pub. No.: US 2015/0179292 A1
(43) Pub. Date: Jun. 25, 2015

(54) X-RAY SHIELD GRADING AND METHOD FOR FABRICATING THE SAME

(71) Applicant: CANON KABUSHIKI KAISHA, Tokyo (JP)

(72) Inventor: Genta Sato, Kawasaki-shi (JP)

(21) Appl. No.: 14/574,205

(22) Filed: Dec. 17, 2014

(30) Foreign Application Priority Data
Dec. 20, 2013 (JP) 2013-263624
Dec. 4, 2014 (JP) 2014-246332

(51) Int. Cl. G21K 1/06

(52) U.S. Cl. CPC G21K 1/067; G21K 2201/067

(57) ABSTRACT

An X-ray shield grating includes a plurality of partial gratings being stacked on each other. In the X-ray shield grating, each of the plurality of partial gratings has a structure in which grating elements, in each of which an X-ray blocking portion and an X-ray transmitting portion are arrayed with a first period, are arrayed with a second period; the first period in each of the plurality of partial gratings is equal to one another; and the second period in each of the plurality of partial gratings is different from one another.

### BACKGROUND OF THE INVENTION

1. Field of the Invention

The present invention relates to X-ray shield gratings and methods for fabricating the X-ray shield gratings.

2. Description of the Related Art

Apparatuses for imaging subjects by using radiation, such as X-rays, are being utilized for various purposes in medical diagnosis and non-destructive testing.

Nowadays, an attempt is being made in which a change in a radiation intensity pattern arising due to the presence or absence of a subject is imaged, and the captured image is then processed so as to obtain an image indicating the absorption intensity, the phase modulation, and the scattering intensity caused by the subject. For example, there is a method (Talbot interferometry) in which a generated interference pattern is detected by using an interferometer that includes an X-ray diffractive grating.

Such an intensity pattern may have a period that is smaller than a pixel of a typical detector. In that case, a method is used in which an image of the intensity pattern is obtained by using an X-ray shield grating (hereinafter, also referred to as an analyzer grating) having a period that is approximately the same as that of the intensity pattern.

In a case in which radiation, such as X-rays, having high optical transparency is used, an analyzer grating needs to have a high aspect ratio, and such an analyzer grating is not easy to fabricate. In addition, in a case in which an X-ray source that is not coherent is used as a radiation source for an interferometer, a method (Talbot-Lau interferometry) in which coherence is applied by using an X-ray shield grating called a source grating is used. The source grating also needs to have a high aspect ratio, as in the case of the analyzer grating. In the present invention and in the present specification, the term “X-ray shield grating” is simply used to refer to both a source grating and an analyzer grating.

Japanese Patent Laid-Open No. 2012-93117 describes a method for fabricating an analyzer grating having a high aspect ratio, in which analyzer gratings each having a low aspect ratio are stacked in a multilayer form. According to the method described in Japanese Patent Laid-Open No. 2012-93117, the analyzer gratings to be stacked on each other are each fabricated by using a nanoimprint process.

### SUMMARY OF THE INVENTION

According to an aspect of the present invention, an X-ray shield grating includes a plurality of partial gratings being stacked on each other. In the X-ray shield grating, each of the plurality of partial gratings has a structure in which grating elements, in each of which an X-ray blocking portion and an X-ray transmitting portion are arrayed with a first period, are arrayed with a second period; the first period in each of the plurality of partial gratings is equal to one another; and the second period in each of the plurality of partial gratings is different from one another.

Further features of the present invention will become apparent from the following description of exemplary embodiments with reference to the attached drawings.

### BRIEF DESCRIPTION OF THE DRAWINGS

FIG. 1 is a schematic diagram for describing a section structure of a diffractive grating according to an embodiment of the present invention.

FIG. 2 is a schematic diagram for describing a partial grating of a one-dimensional pattern included in a diffractive grating according to an embodiment of the present invention.

FIGS. 3A and 3B are schematic diagrams for describing a partial grating of a two-dimensional pattern included in a diffractive grating according to an embodiment of the present invention.

FIG. 4 is a schematic diagram for describing a partial grating of a one-dimensional pattern included in a diffractive grating according to an embodiment of the present invention.

FIG. 5 is a schematic diagram for describing a structure of a partial grating included in a diffractive grating according to an embodiment of the present invention.

FIG. 6 is a schematic diagram for describing a section structure of a diffractive grating according to an embodiment of the present invention.

FIGS. 7A through 7J are schematic diagrams for describing a process of fabricating a diffractive grating according to a first exemplary embodiment of the present invention.

FIGS. 8A through 8J are schematic diagrams for describing a process of fabricating a diffractive grating according to a sixth exemplary embodiment of the present invention.

FIGS. 9A through 9J are schematic diagrams for describing a process of fabricating a diffractive grating according to a fifth exemplary embodiment of the present invention.

### DESCRIPTION OF THE EMBODIMENTS

In the fabrication method described in Japanese Patent Laid-Open No. 2012-93117, a plurality of shield gratings having mutually different periods are used in order to handle divergent X-rays. In order to fabricate a plurality of analyzer gratings having mutually different periods, molds need to be fabricated for the respective periods, which increases the cost. This situation applies similarly to a case in which a shield grating is fabricated through a method other than the nanoimprint process.

As a method for fabricating an X-ray shield grating, other than the nanoimprint process, photolithography or an LIGA process is typically employed, but when these techniques are used, photomasks need to be fabricated for the respective periods, which increases the cost.

Hereinafter, an X-ray shield grating and a method for fabricating the X-ray shield grating according to an embodiment of the present invention will be described with reference to the drawings.

According to the X-ray shield grating and the method for fabricating the X-ray shield grating according to the present embodiment, an X-ray shield grating and a method for fabricating the X-ray shield grating that can achieve a higher aspect ratio at a lower cost can be provided, as compared to a case in which an X-ray shield grating is fabricated by using the fabrication method described in Japanese Patent Laid-Open No. 2012-93117. It is to be noted that, in each of the drawings, identical members are given identical reference characters and duplicate descriptions thereof will be omitted.

### Embodiments

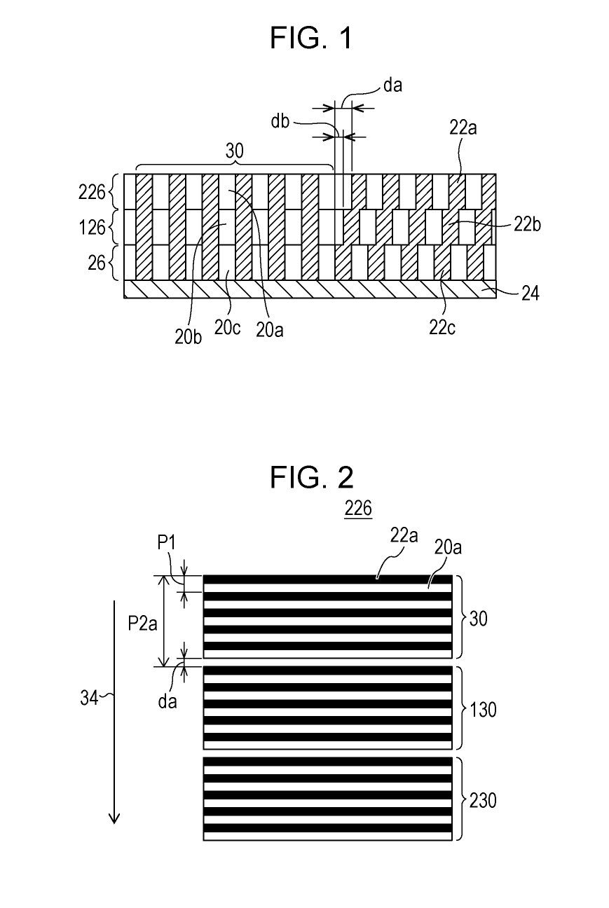

An X-ray shield grating according to the present embodiment has a section structure as illustrated in FIG. 1.

The shield grating is formed on a substrate 24. The shield grating has a layered structure in which a plurality of partial gratings 26, 126, and 226 each having a low aspect ratio are stacked on each other.

Although an example in which the partial gratings 26, 126, and 226 are stacked in three layers in the shield grating according to the present embodiment is illustrated in FIG. 1 for simplicity, the present invention is not limited to such a configuration.

Each of the plurality of partial gratings 26, 126, and 226 has a structure in which grating elements 30 are arrayed along the same plane.

FIG. 2 illustrates a schematic diagram of the partial grating 226 serving as an example of a partial grating formed by arraying a plurality of grating elements along the same plane. In the partial grating 226, belt-shaped X-ray blocking portions 22a are arrayed in a one-dimensional pattern.

In the partial grating 226, a plurality of grating elements 30, 130, and 230 are arrayed with a second period P2a, and a space da is present between adjacent two of the grating elements 30, 130, and 230. In each of the grating elements 30, 130, and 230, an X-ray blocking portion 22a and an X-ray transmitting portion 20a are arrayed with a first period P1 in a first periodic direction 34. The first period P1 in the grating element 30 is set to be the same in all of the partial gratings 26, 126, and 226. Meanwhile, the second period P2a differs among the partial gratings 26, 126, and 226. Thus, as illustrated in FIG. 1, a space between adjacent grating elements in the partial grating 26 (also referred to as a first partial grating) differs from a space db between adjacent grating elements in the partial grating 126 (also referred to as a second partial grating) that is stacked on the partial grating 26. The space db in the second partial grating 126 also differs from a space da between adjacent grating elements in the partial grating 226 (also referred to as a third partial grating) that is stacked on the second partial grating 126. In FIG. 1, a space dc between adjacent grating elements in the first partial grating 26 is 0 and is thus not illustrated. In this manner, when da>db>dc holds true, the second period P2a in the second partial grating 126 is greater than the second period P2a in the first partial grating 26, and the second period P2a in the third partial grating 226 is greater than the second period P2a in the second partial grating 126. Through this, angles of an X-ray transmitting area and of an X-ray blocking area relative to the substrate 24 can be varied in accordance with positions within a grating plane. It is to be noted that an X-ray transmitting area is an area that is formed by X-ray transmitting portions 20a, 20b, and 20c of the respective partial gratings 26, 126, and 226 being connected to one another. In a similar manner, an X-ray blocking area is an area that is formed by X-ray blocking portions 22a, 22b, and 22c of the respective partial gratings 26, 126, and 226 being connected to one another. In this manner, by varying the angles of the X-ray transmitting area and of the X-ray blocking area relative to the substrate 24, for example, the direction in which the X-ray transmitting area extends can be brought closer to any given direction in which X-rays are incident, and thus vignetting of X-rays can advantageously be reduced.

For example, in FIG. 1, divergent X-rays are incident on the substrate 24 from a side opposite to the side on which the first partial grating 26 is formed. In that case, it is desirable that the second period P2a in the first partial grating 26, which is located closer to the side on which the X-rays are incident, be set smaller than the second period P2a in the second partial grating 126, which is located closer to the side from which the X-rays exit. In addition, it is desirable that the second period P2a in the second partial grating 126 be set smaller than the second period P2a in the third partial grating 226, which is located even closer to the side from which the X-rays exit than the second partial grating 126. In other words, it is desirable that the second period P2a monotonously increase as a function of the distance from a plane on which X-rays are incident. However, with respect to a shield grating alone, as long as the second period P2a monotonously increases or monotonously decreases among the partial gratings, such a shield grating can be used such that the second period P2a monotonously increases as a function of the distance from the plane on which X-rays are incident. It is to be noted that the term “monotonous increase” encompasses not only a case in which y continuously increases along with an increase in x but also a case in which y remains constant at some point. In a similar manner, the term “monotonous decrease” encompasses not only a case in which y continuously decreases along with a decrease in x but also a case in which y remains constant at some point. In other words, in the present specification and in the present invention, even a case in which the second period P2a increases stepwise as a function of the distance from the plane on which X-rays are incident is regarded as that the second period P2a monotonously increases as a function of the distance from the plane on which X-rays are incident. As illustrated in FIG. 1, the partial gratings 26, 126, and 226 are stacked in such a manner that a group of grating elements 30 of the respective partial gratings 26, 126, and 226 overlap each other and the X-ray transmitting areas 20 defined in the grating elements 30 are perpendicular to the substrate 24.

Such a group of grating elements 30 formed when the partial gratings 26, 126, and 226 are stacked in the aforementioned manner is referred to as an optical axis grating element. As the second period P2a of the partial grating 226, which is located farther from the substrate 24, is set greater, the X-ray transmitting area and the X-ray blocking area (area formed by the X-ray blocking portions 22a, 22b, and 22c of the respective partial gratings 26, 126, and 226) are more inclined relative to the substrate 24 in an area farther from the optical axis grating element.

Through this, vignetting that occurs to divergent X-rays incident on the substrate 24 from the side opposite to the side on which the partial grating 26 is formed can be reduced.

It is desirable that the length of a side of the grating element 30 that is parallel to the first periodic direction 34 be shorter than the second period P2a. With such a configuration, a space d (da, db, or dc) between adjacent two of the grating elements 30, 130, and 230 takes a value that is greater 0, which makes it possible to prevent adjacent two of the grating elements 30, 130, and 230 from overlapping each other. If adjacent two of the grating elements 30, 130, and 230 overlap each other, the X-ray blocking area is more likely to overlap the X-ray transmitting area, which reduces the amount of transmitted X-rays.

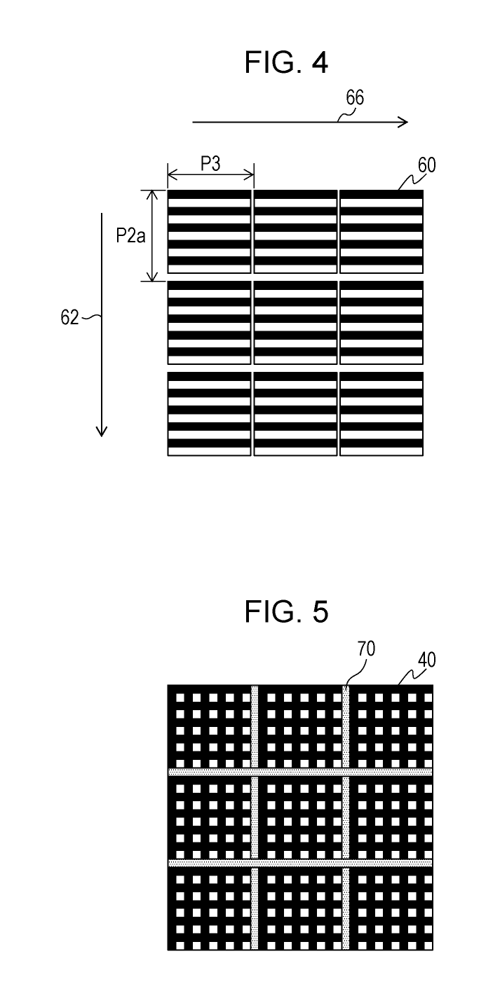

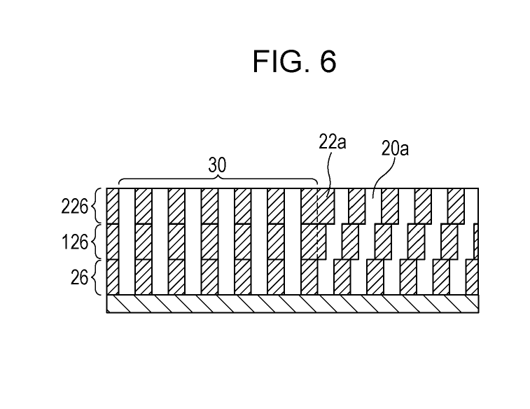

In addition, as illustrated in FIG. 6, a space between adjacent grating elements may be filled with an X-ray blocking material. In a case in which the length of a side of the grating element 30 that is parallel to the first periodic direction 34 is shorter than the second period P2a, a gap is generated between adjacent grating elements, and if this gap is excessively large, an excess amount of X-rays is transmitted. If such a shield grating is used as an analyzer grating or a source grating, an interference fringe is degraded locally. In that case, filling the gap between adjacent grating elements with an X-ray blocking material makes it possible to prevent degradation of the interference fringe.

In the grating element 30, X-ray blocking portions 22a and X-ray transmitting portions 20a may be arrayed in one direction or may be arrayed in two or more directions. In a case in which the X-ray blocking portions 22a and the X-ray transmitting portions 20a are arrayed in one direction, this configuration is described such that the grating element 30 has a one-dimensional pattern shape, and in a case in which the X-ray blocking portions 22a and the X-ray transmitting portions 20a are arrayed in two directions, this configuration is described such that the grating element 30 has a two-dimensional pattern shape.

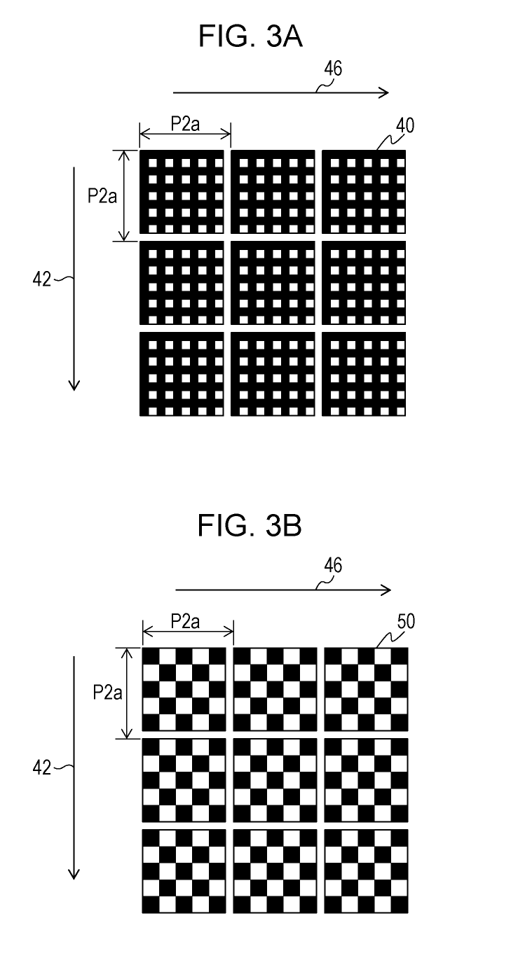

The two-dimensional pattern includes, for example, a lattice-like pattern illustrated in FIG. 3A. A partial grating illustrated in FIG. 3A includes a plurality of grating elements 40 each having a lattice-like pattern. Periodic directions of the pattern of the grating element 40 having a lattice pattern extend in a y-direction 42 and an x-direction 46 that intersects with the y-direction 42.

In a case in which grating elements having a two-dimensional pattern shape are arrayed in two directions, in order to reduce vignetting of X-rays, it is desirable that the second period P2a differ among the partial gratings in the second periodic direction 42 as well. Through this, the angle of the X-ray transmitting area 20 relative to the substrate 24 in either periodic direction within a plane can be varied. It is to be noted that although a case in which the second period P2a in the y-direction 42 is equal to the second period P2a in the x-direction 46 is illustrated in FIG. 3A, the grating elements may be arrayed with different periods in the x-direction 46 and the y-direction 42.

The grating element having a two-dimensional pattern shape may be a grating element 50 having a checkered (checkered lattice) pattern illustrated in FIG. 3B, or another grating element may be employed.

In addition, the shape of an X-ray transmitting portion 20a in a grating element may be rectangular (quadrangular) as illustrated in FIG. 3A or in FIG. 3B, or may be in another shape. For example, the shape of the X-ray transmitting portion 20a may be circular.

In addition, grating elements may be disposed in such a manner that the periodic direction thereof extends in a direction that is different from the directions in which the X-ray blocking portions 22a and the X-ray transmitting portion 20a are arrayed.

For example, in a case in which grating elements each having a one-dimensional pattern are arrayed, as illustrated in FIG. 4, grating elements 60 may be arrayed with a third period P3 extending in a direction (x-direction) 66 that is orthogonal to a direction (y-direction) 62 in which the X-ray blocking portions 22a and the X-ray transmitting portions 20a are arrayed in the grating element 60.

In order to prevent a pattern from disappearing, it is desirable that there be no space between grating elements adjacent in the direction 66 that is orthogonal to the direction 62 in which the X-ray blocking portions 22a and the X-ray transmitting portions 20a are arrayed. Therefore, it is desirable that the grating elements 60 be disposed, for example, with the third period P3 that is different from the second period P2a necessary for adjusting the angle of the X-ray transmitting area and the angle of the X-ray blocking area and that is equal to the length of a side of the grating element 60.

### Exemplary Embodiments

Hereinafter, exemplary embodiments of the present invention will be described. A shield grating according to the exemplary embodiments can be applied to an analyzer grating or a source grating as well.

### First Exemplary Embodiment

As a first exemplary embodiment, a shield grating that includes a grating element 30 having a one-dimensional pattern that is fabricated through the LIGA process will be described.

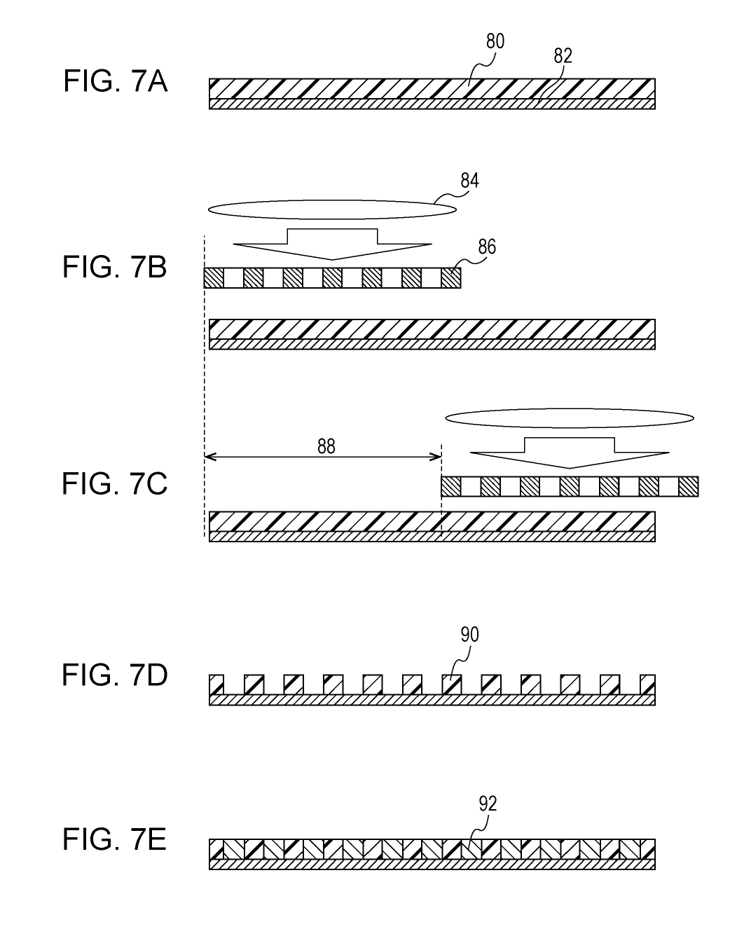

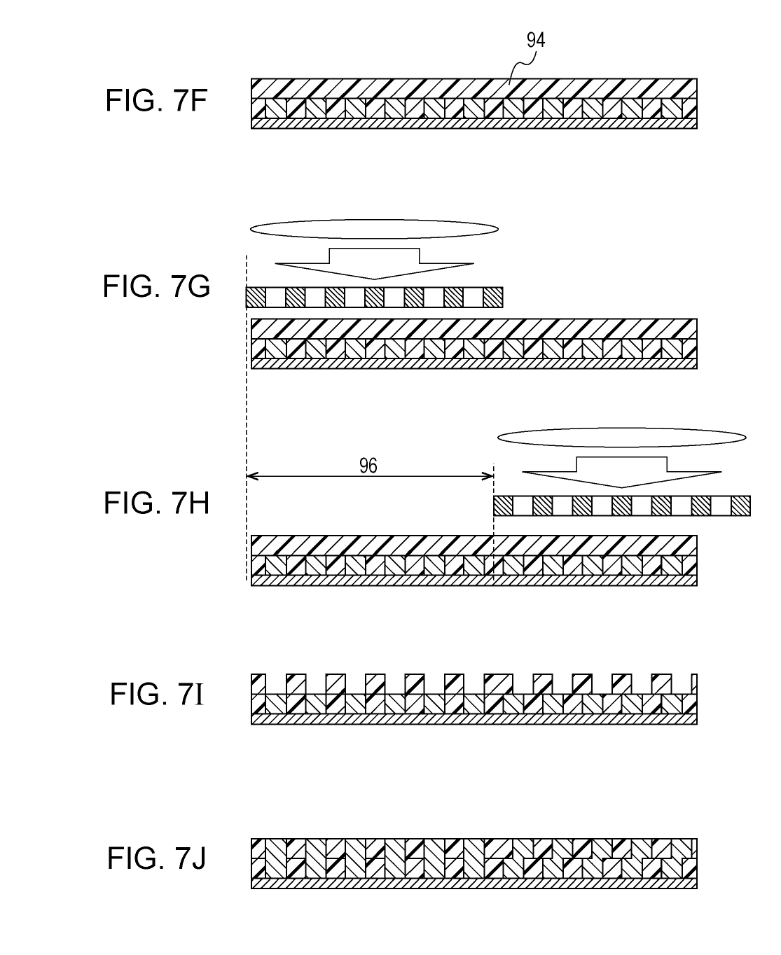

In the present exemplary embodiment, the partial grating 26 illustrated in FIG. 2 is used. The process will be described with reference to FIGS. 7A through 7J.

A positive photoresist, which is removed at an area irradiated with light in a development process, is applied on a six-inch silicon wafer 82 (substrate) to form a first photoresist layer 80 having a thickness of 50 μm (FIG. 7A).

Then, with the use of a photomask 86 in which belt-like patterns having a length of 100 mm are arrayed in 5000 cycles at a pitch of 10 μm and with L/S=1/1, the first photoresist layer 80 is subjected to patterning by a light source 84 (FIG. 7B).

Through a step and repeat process, the pattern is printed on the entire surface of the silicon wafer 82. A first step period 88 (corresponding to the second period in the first partial grating) corresponding to an amount by which the photomask 86 is moved in one step during patterning is 50000.0 μm (FIG. 7C).

A pattern 90 obtained through the development process is filled with gold 92 through plating so as to fabricate the first partial grating. In a case in which the gold 92 grows so as to exceed the pattern 90, the gold 92 may be ground so as to become planar (FIGS. 7D, 7E).

A second photoresist layer 94 is then formed (FIG. 7F).

Subsequently, the photomask 86 is aligned in such a manner that a step at the center of the silicon wafer 82 matches a corresponding step in the first photoresist layer 80, and the exposure is then carried out (FIG. 7G).

Thereafter, with a second step period set to 50002.5 μm, the entire surface of the silicon wafer 82 is exposed through the step and repeat process (FIG. 7H). Then, through the development process and gold plating, the second partial grating is fabricated (FIGS. 7I, 7J).

A similar process is then repeated with a third step period set to 50005.0 μm, and thus the third partial grating is fabricated.

Through this, a shield grating having gold in a thickness of 150 μm and having a period of 10 μm can be obtained, and such a shield grating is compatible with divergent X-rays emitted from an X-ray source spaced apart by a distance of 150 cm.

### Second Exemplary Embodiment

As a second exemplary embodiment, a configuration example of a shield grating that includes a partial grating in which the grating elements 60 are arrayed in the direction (y-direction) 62 in which the X-ray blocking portions 22a and the X-ray transmitting portions 20a are arrayed and in the direction (x-direction) 66 that is orthogonal to the direction 62 will be described.

The partial grating according to the present exemplary embodiment will be described with reference to FIG. 4.

The second exemplary embodiment differs from the first exemplary embodiment in that the length of the belt-like patterns formed in the photomask 86 is 50 mm and differs in terms of a method of moving the photomask 86 in the step and repeat process.

The second exemplary embodiment is similar to the first exemplary embodiment in other respects, and thus description thereof will be omitted.

The photomask 86 is moved in the x-direction 66 with a fourth step period (corresponding to P3) that is different from the step period with which the photomask 86 is moved in the y-direction.

Specifically, the photomask 86 is moved at the fourth step period of 50000.0 μm, and the fourth period is the same for the entire partial gratings (first through third partial gratings).

Meanwhile, the step period in the y-direction is the same as that of the first exemplary embodiment.

In the process of fabricating the partial grating, with the step period similar to that of the first exemplary embodiment and the fourth step period set as moving amounts, the step and repeat process is repeated in a matrix pattern so as to fabricate the partial grating. Through this, a one-dimensional shield grating having gold in a thickness of 150 μm and having a period of 10 μm can be obtained, and such a shield grating is compatible with divergent X-rays emitted from an X-ray source spaced apart by a distance of 150 cm.

### Third Exemplary Embodiment

As a third exemplary embodiment, a configuration example of a shield grating in which a grating element has a two-dimensional pattern will be described.

The present exemplary embodiment differs from the first exemplary embodiment in terms of the shape of the photomask 86 and an operation during exposure.

The partial grating according to the present exemplary embodiment will be described with reference to FIG. 3A.

The grating element 40 has a shape in which the X-ray blocking area is a lattice pattern.

The X-ray blocking area is arrayed at a pitch of 10 μm and with L/S=1/1 both in one direction (referred to as the y-direction in the present exemplary embodiment) 42 of the directions in which the X-ray blocking portions 20a and the X-ray transmitting portions 22a are arrayed and in the direction (referred to as the x-direction in the present exemplary embodiment) 46 that is orthogonal to the direction 42.

A pattern having 5000 cycles both in the y-direction 42 and in the x-direction 46 is formed in the photomask 86, which results in a mask pattern area of 50 mm×50 mm.

A photoresist is exposed through the step and repeat process so as to be scanned in a matrix pattern.

The step period in the y-direction 42 is equal to the step period in the x-direction 46.

The step period in the first partial grating is 50000.0 μm; the step period in the second partial grating is 50002.5 μm; and the step period in the third partial grating is 50005.0 μm.

Through this, a shield grating of a lattice pattern having gold in a thickness of 150 μm and having a period of 10 μm can be obtained, and such a shield grating is compatible with divergent X-rays emitted from an X-ray source spaced apart by a distance of 150 cm.

### Fourth Exemplary Embodiment

As a fourth exemplary embodiment, an example of a method for fabricating a partial grating in which a gap between one grating element and another grating element is filled with an X-ray blocking material within the partial grating will be described.

As an example of the fabrication method, a case in which the LIGA process is used will be described.

Unlike the process employed in the third exemplary embodiment, a negative photoresist is used instead of a positive photoresist. Other processes are similar to those of the third exemplary embodiment.

As the negative photoresist is used, the X-ray transmitting portions 20a are formed through a mask pattern, as illustrated in FIG. 6.

In the process of fabricating each partial grating, as the interior of the partial grating is plated, gaps between adjacent grating elements can be simultaneously filled with gold.

As a result, as illustrated in FIG. 5, a shield grating of a lattice pattern in which the gaps between adjacent grating elements are filled with an X-ray blocking material 70 can be obtained.

### Fifth Exemplary Embodiment

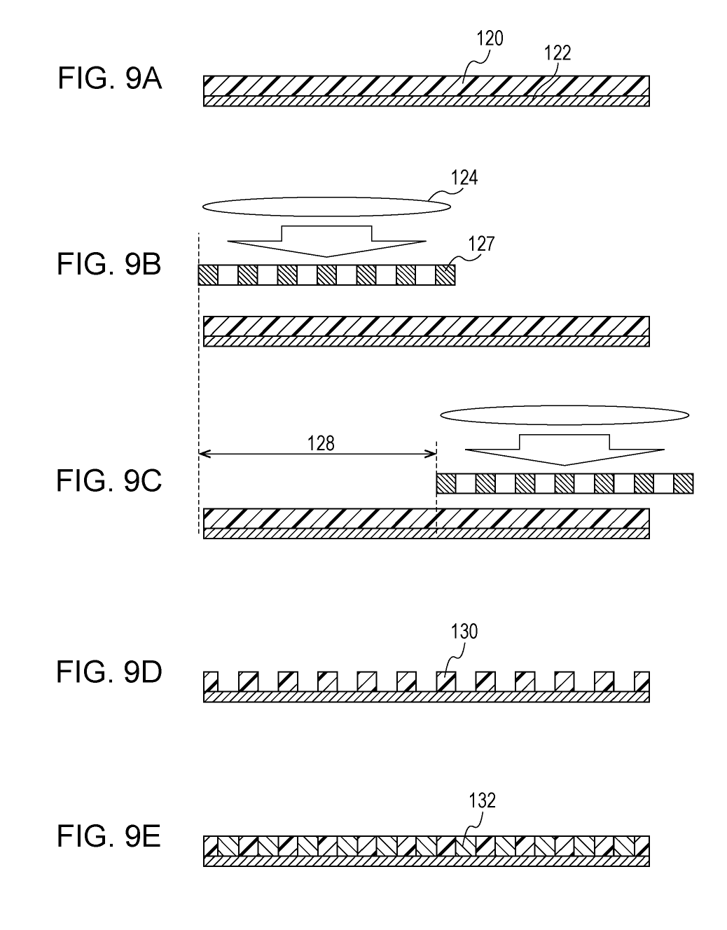

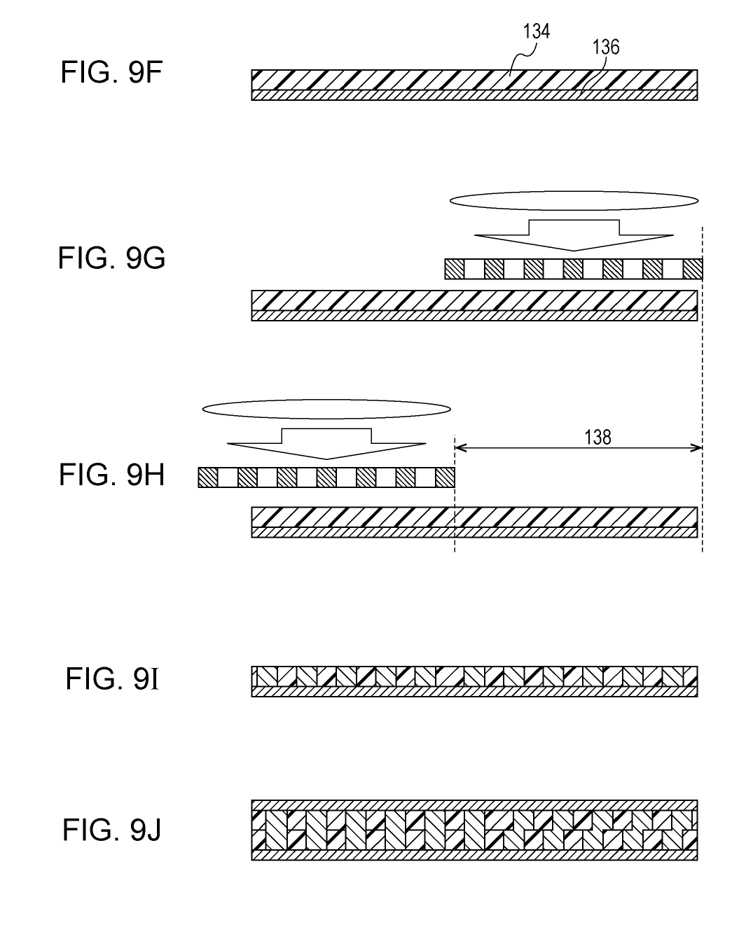

As a fifth exemplary embodiment, an example of a method for fabricating a shield grating that includes a second partial grating formed on a substrate separate from a substrate for a first partial grating will be described with reference to FIGS. 9A through 9J.

The present exemplary embodiment differs from the first exemplary embodiment in terms of a process of fabricating the second partial grating. The pattern for the partial gratings is the same as that of the first exemplary embodiment. In addition, the process of fabricating the first partial grating is the same as that in the first exemplary embodiment (FIG. 9A through FIG. 9E), and thus descriptions thereof will be omitted.

A second photoresist layer 134 having a thickness of 50 μm is formed on a second silicon wafer 136 (second substrate) (FIG. 9F). Thereafter, with a second step period 138 set to 50002.5 μm, the entire surface of the second silicon wafer 136 is exposed through the step and repeat process (FIG. 9H). Then, through the development process and gold plating, the second partial grating is fabricated (FIG. 9I). Lastly, the first silicon wafer 122 and the second silicon wafer 136 are aligned and bonded in a state in which the first partial grating and the second partial grating face each other in such a manner that the X-ray blocking portions and the X-ray transmitting portions of the grating element formed at the center of the first silicon wafer 122 overlap, respectively, the X-ray blocking portions and the X-ray transmitting portions of the grating element formed at the center of the second silicon wafer 136 (FIG. 9J). In this manner, a shield grating having gold in a thickness of 100 μm and having a period of 10 μm can be obtained, and such a shield grating is compatible with divergent X-rays emitted from an X-ray source spaced apart by a distance of 150 cm. As a bonding method, a resin bonding method, a silicon direct bonding method, a metal bonding method, or the like may be employed. A joining layer may be provided between faces that are to be bonded. In addition, one or both of the first silicon wafer 122 and the second silicon wafer 136 may be bonded with a partial grating. For bonding, an alignment mark may be provided in an area where a partial grating is not present. It is to be noted that the number of partial gratings to be bonded may be two or more. In a case in which three or more partial gratings are to be bond, the silicon wafers may be removed.

### Sixth Exemplary Embodiment

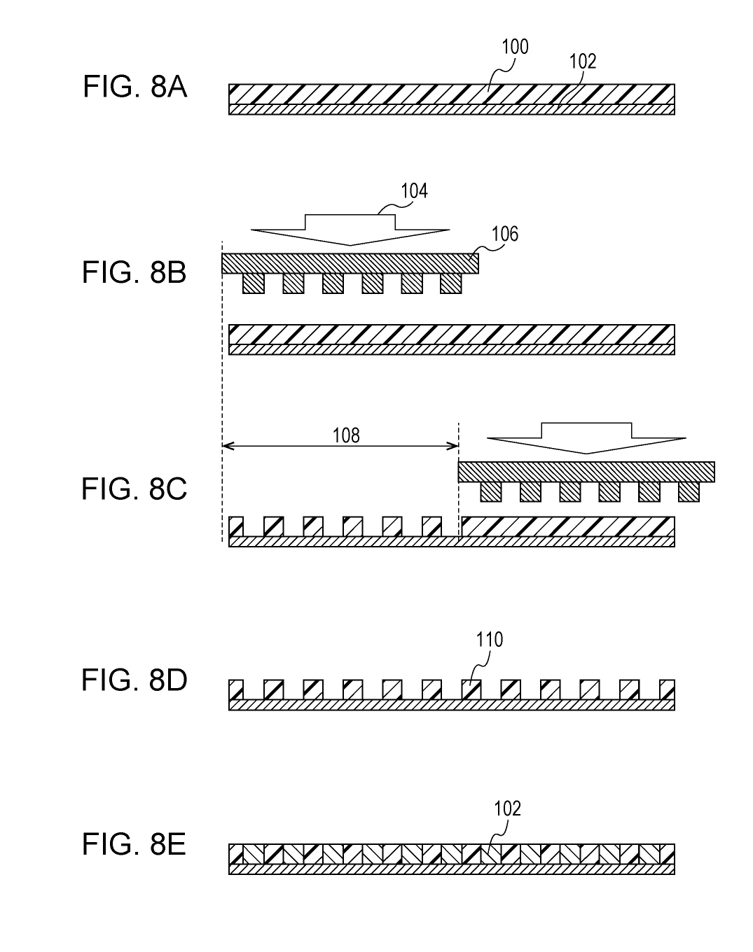

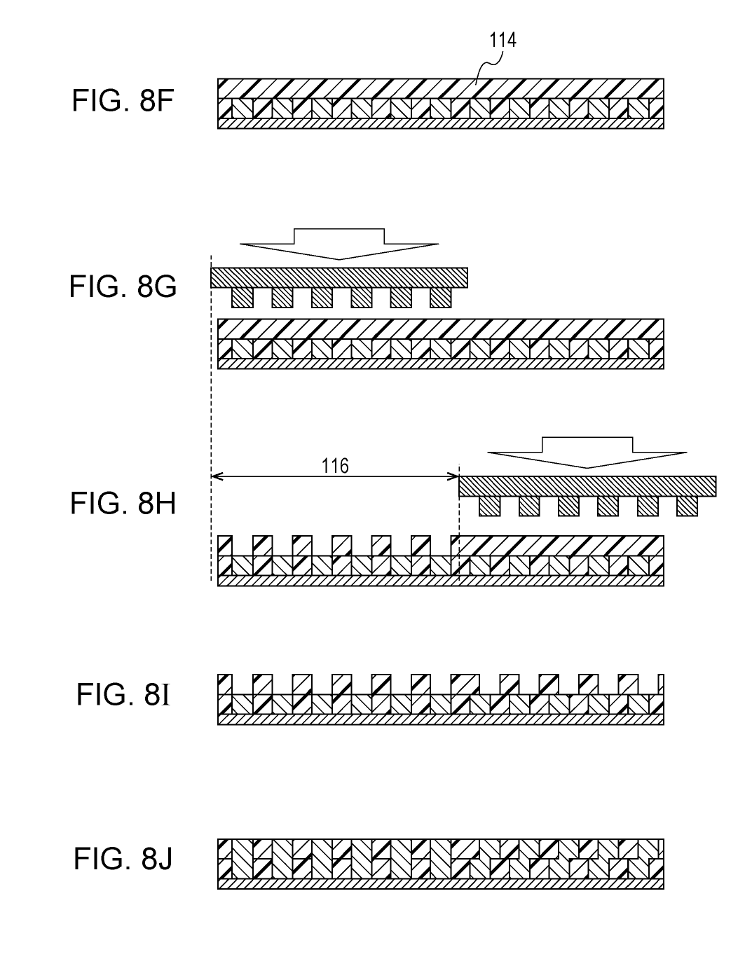

As a sixth exemplary embodiment, an example of a method for fabricating a shield grating that includes a grating element 30 having a one-dimensional pattern formed through an imprint technique will be described with reference to FIGS. 8A through 8J.

The pattern for the partial grating is the same as that of the first exemplary embodiment. The sixth exemplary embodiment differs from the first exemplary embodiment in that an ultraviolet (UV) curable resin layer 100 is used in place of the first photoresist layer 80 and differs in that a transparent mold 106 is used in place of the photomask 86.

The first UV curable resin layer 100 is formed on a silicon wafer 102 (FIG. 8A).

Then, the transparent mold 106 is pressed against the first UV curable resin layer 100, and the first UV curable resin layer 100 is cured with ultraviolet radiation 104 (FIG. 8B).

Belt-shaped protrusion patterns each having a height of 50 μm are arrayed in the transparent mold 106 in 5000 cycles at a pitch of 10 μm and with L/S=1/1.

After the transparent mold 106 is once separated from the UV curable resin layer 100, the transparent mold 106 is translated by a first moving distance 108 of 50000.0 μm. The UV curable resin layer 100 is then subjected to patterning again, and this process is repeated (FIG. 8C).

Thereafter, a fabricated pattern 110 is filled with gold 102 through plating (FIGS. 8D, 8E). A similar process is carried out on a second UV curable resin layer 114 and on a third UV curable resin layer (FIGS. 8F, 8G).

At this point, the transparent mold 106 is moved by a moving distance 116 of 50002.5 μm when patterning the second UV curable resin layer 114 (FIG. 8H), and moved by a moving distance of 50005.5 μm when patterning the third UV curable resin layer.

In this manner, a shield grating having gold in a thickness of 150 μm and having a period of 10 μm can be obtained, and such a shield grating is compatible with divergent X-rays emitted from an X-ray source spaced apart by a distance of 150 cm (FIGS. 8I, 8J).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-263624, filed Dec. 20, 2013, and No. 2014-246332, filed Dec. 4, 2014 which are hereby incorporated by reference herein in their entirety.

What is claimed is:

1. An X-ray shield grating including a plurality of partial gratings being stacked on each other,
wherein each of the plurality of partial gratings has a structure in which grating elements, in each of which an X-ray blocking portion and an X-ray transmitting portion are arrayed with a first period, are arrayed with a second period,
wherein the first period in each of the plurality of partial gratings is equal to one another, and
wherein the second period in each of the plurality of partial gratings is different from one another.

2. The X-ray shield grating according to claim 1,
wherein the second period of one of the partial gratings that is located closer to a side on which X-rays are incident is shorter than the second period of another one of the partial gratings that is located closer to a side from which the X-rays exit.

3. The X-ray shield grating according to claim 1,
wherein the length of a side of the grating element is shorter than the second period.

4. The X-ray shield grating according to claim 1,
wherein, in each of the plurality of partial gratings, a gap between the grating elements is filled with an X-ray blocking material.

5. The X-ray shield grating according to claim 1,
wherein, in the grating element, the X-ray blocking portions and the X-ray transmitting portions are arrayed in two or more directions, and
wherein, in each of the plurality of partial gratings, the grating elements are arrayed in two or more directions.

6. The X-ray shield grating according to claim 5,
wherein, in the grating element, the X-ray blocking portions and the X-ray transmitting portions are arrayed in a lattice pattern.

7. The X-ray shield grating according to claim 5,
wherein, in the grating element, the X-ray blocking portions and the X-ray transmitting portions are arrayed in a checkered pattern.

8. The X-ray shield grating according to claim 1,
wherein the grating elements are arrayed with a third period in a direction that intersects with a direction of the first period, the third period being different from the second period.

9. A method for fabricating an X-ray shield grating that includes a plurality of partial gratings being stacked on each other, the method comprising:
forming a first partial grating by arraying grating elements, in each of which an X-ray blocking portion and an X-ray transmitting portion are arrayed with a first period, with a second period; and
forming a second partial grating by arraying grating elements, in each of which an X-ray blocking portion and an X-ray transmitting portion are arrayed with the first period, with the second period,
wherein the second period in the forming of the second partial grating is different from the second period in the forming of the first partial grating.

10. The method for fabricating the X-ray shield grating according to claim 9,
wherein, in the forming of the first partial grating and in the forming of the second partial grating, a process is used in which, through a step and repeat process, a photoresist layer formed on a substrate is exposed and patterned by using a mask having a pattern of the first period.

11. The method for fabricating the X-ray shield grating according to claim 9,
wherein, in the forming of the first partial grating and in the forming of the second partial grating, an imprint process is used in which a mold having a pattern of the first period is pressed against a UV curable resin layer formed on a substrate and the UV curable resin is cured with ultraviolet radiation for patterning.
